(19) United States
(12) Patent Application Publication
(10) Pub. No.: US 2010/0283285 A1
(43) Pub. Date: Nov. 11, 2010

(54) TARPAULIN COVER SYSTEM FOR SIDE DUMP VEHICLES

(76) Inventors: Michael Cramaro, Indian Harbor Beach, FL (US); Todd Kuriga, Melbourne, FL (US); Klaas Pauli, North Las Vegas, NV (US)

Correspondence Address: CONNOLLY BOVE LODGE & HUTZ, LLP, P O BOX 2207, WILMINGTON, DE, 19899, US

(21) Appl. No.: 12/547,776

(22) Filed: Aug. 26, 2009

Related U.S. Application Data
(60) Provisional application No. 61/176,646, filed on May 8, 2009.

(51) Int. Cl. B60J 11/00

(52) U.S. Cl. 296/98

(57) ABSTRACT

A tarpaulin cover system selectively covers and uncovers the body of a vehicle. The system includes an elongated anchored support member mounted to one side of the vehicle body. A tarpaulin is secured at one of its sides to the anchored support member to be fixedly mounted to that side of the body. The other side of the tarpaulin is secured to an elongated movable support member. A pivot point assembly is mounted to each of the front and the rear of the body. A pivot arm is pivotally mounted to each pivot point assembly. A pivot head assembly connects each pivot arm to the movable support member by an intermediate pivot head assembly. The pivot head assemblies are pivotally mounted to each pivot arm. A traction roller is mounted on each end of the movable support member. The traction could also be achieved by a traction pad on the vehicle body in addition to or instead of the traction roller. The movable support member is not mounted directly to the shaft of the motor of the system.

### CROSS REFERENCE TO RELATED APPLICATION

This application is based on provisional application Ser. No. 61/176,646 filed May 8, 2009, all of the details of which are incorporated herein by reference thereto.

### BACKGROUND OF INVENTION

Various tarpaulin cover systems exist for covering the contents in a body of a vehicle, such as a trailer or truck. A known system uses a tarpaulin mounted to bows which can be moved from an open position where the vehicle body is essentially completely exposed to a closed position where the vehicle body is completely covered. The movement of the tarpaulin is in a longitudinal direction with regard to the vehicle body. The movement is effected through use of different types of crank mechanisms.

Cover systems have been used where the tarpaulin is also moved from side to side. In addition, cover systems have been used for dump trucks or trailers where the front end rotates upwardly for rear end dump vehicles. Thus, tarpaulin cover systems are known for dump-type vehicle bodies, as well as stationary vehicle bodies.

Tarpaulin cover systems are also known for side dump trailers or trucks. In such systems the tarpaulin is moved in a transverse direction laterally from one side of the vehicle to the other side so that the tarpaulin can be disposed in an out of the way location in the open position when the body of the vehicle is being rotated to dump its contents or when the contents are being loaded into the body.

### SUMMARY OF THE INVENTION

An object of this invention is to provide a tarpaulin cover system which is particularly useful for a side dump vehicle, although the invention could be used with other types of vehicles or trailers.

A further object of this invention is to provide such a system which is electrically operated.

A still further object of this invention is to provide such a system wherein the tarpaulin can easily clear heaped loads as it moves over the vehicle body.

In accordance with a preferred practice of this invention the tarpaulin cover system includes an elongated anchored support member or permanent pipe permanently fixed to one side of the vehicle body and affixed to one side of the tarpaulin to anchor that side of the tarpaulin to the vehicle body. The opposite side of the tarpaulin is secured to an elongated moveable support member or roller tube which is mounted at each end to one end of a pivot arm through an intermediate pivot head assembly. The opposite end of each pivot arm is pivotally secured to a pivot point assembly mounted to the vehicle body at the front and rear of the body.

In accordance with one aspect of this invention each pivot head assembly is pivotally secured to the pivot arm so that the pivot head assembly could be tucked under and disposed at the side rail on each side of the vehicle body when the tarpaulin is in its open and in its closed positions. The pivot head assembly could be disposed under but spaced from the side rail when the tarpaulin is in a relaxed condition where, for example, no load is in the vehicle body.

In accordance with a further aspect of this invention each pivot head assembly may include an indicator structure for adjusting the specific orientation of the pivot head assembly and the spring force at the pivot connection to the pivot arm. Such structure would include an indicator plate having a pin selectively mounted in one of a plurality of holes in the pivot head assembly plate. The indicator plate may have a shaft at the pivot connection for pivotally connecting the pivot head assembly with the pivot arm. A plurality of torsion springs may be connected to the shaft and to the pivot arm for adjusting the spring pressure at each pivot head assembly.

In accordance with a still further aspect of this invention one of the pivot head assemblies, such as the front pivot head assembly, is motorized while the other or rear pivot head assembly is an idler pivot head assembly. The movable support arm for the tarpaulin is connected to the motor shaft at the front pivot head assembly through a pair of spaced sprockets with an intermediate drive chain so that there is not a direct connection of the tarpaulin support member or roller tube with the motor.

In yet another aspect of this invention a traction roller is provided on each end of the movable support member for the tarpaulin. The traction roller is preferably of a size that is greater than the diameter of the rolled tarpaulin. As a result, the traction roller makes contact with the vehicle body before the tarpaulin. This facilitates the system climbing out and into the open and closed positions.

### THE DRAWINGS

FIG. 1 is an exploded view of the tarpaulin cover system in accordance with this invention;

FIG. 2 is a front elevational view of the tarpaulin system of FIG. 1 in the relaxed position;

FIG. 3 is a front elevational view of the tarpaulin system of FIGS. 1-2 showing the sequence of movement between the relaxed and open positions;

FIG. 4 is a front elevational view of the tarpaulin system of FIGS. 1-3 in the open position;

FIG. 5 is a front elevational view of the tarpaulin system of FIGS. 1-4 in the closed position;

FIG. 6 is a perspective view of the tarpaulin system of FIGS. 1-5 in the closed position; and

FIG. 7 is an exploded view of the front pivot head assembly of the tarpaulin system of FIGS. 1-6.

### DETAILED DESCRIPTION

The present invention is used to cover/uncover the body of a vehicle, such as a trailer or truck, with a tarpaulin. The tarpaulin could be moved longitudinally such as in a front/rear direction or could be moved laterally from side to side. The vehicle body could be stationary or could be of a dump type where the dumping is an end dumping or is a side dumping. The invention will be described for a side dump trailer. It is to be understood, however, that other types of vehicle bodies could be used.

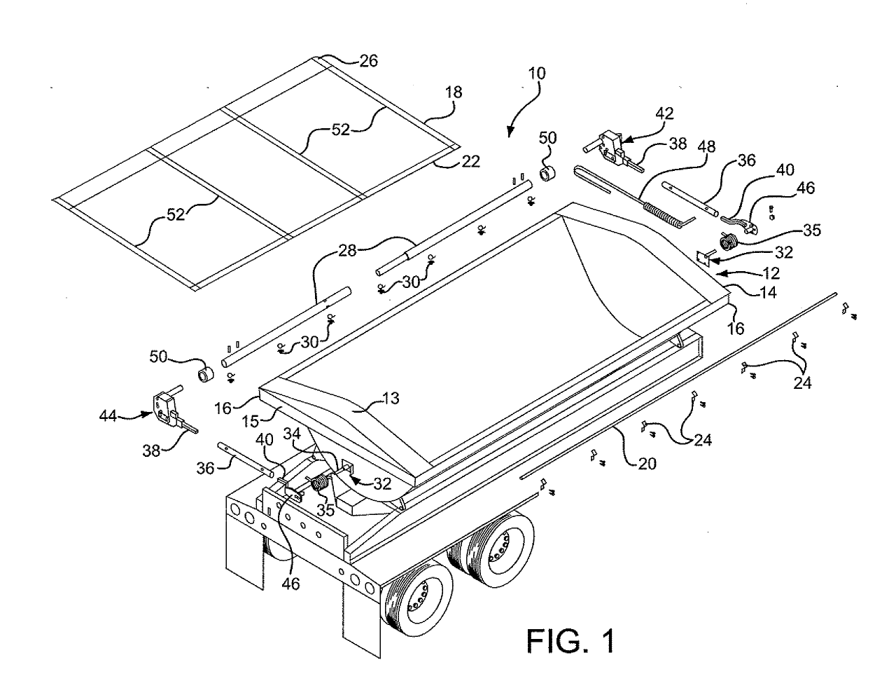

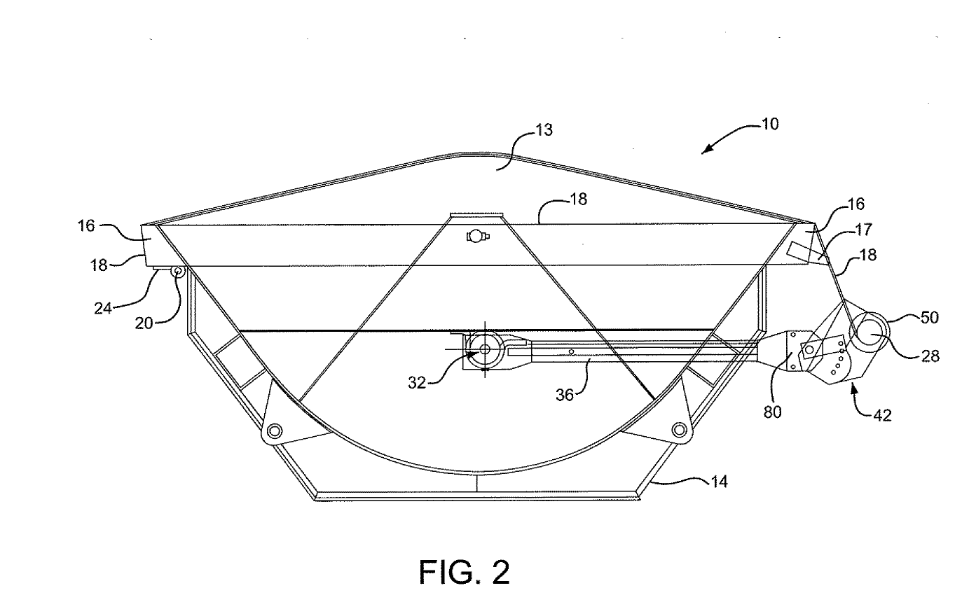

FIG. 1 shows the components of a tarpaulin cover system 10 in accordance with one preferred practice of this invention. The system 10 is particularly adapted for use with a side dump vehicle 12, such as a side dump trailer or truck having a body 14. Body 14 has front and rear bulkheads 13 which may be considered as a front side and an opposite rear side. Such front and rear bulkheads are usually made of sheet metal. Each bulkhead 13 is usually a skin that protrudes past the outermost edge at the top and sides of the body 14. As shown in FIG. 1 this results in a protruding lip 15. A side rail 16 extends outwardly along each of the opposite lateral sides of the body 14. A flat bar 17 which is illustrated, for example, in FIGS. 2-5 is located at the lip 15. The tarpaulin system 10 includes a tarpaulin (“tarp”) 18 which would selectively cover and uncover or expose the interior of the body 14 by selective movement from side to side over the top of body 14. The flat bar 17 aids in the positioning of the tarpaulin. For example, when the tarpaulin is moved in a clockwise direction the tarpaulin grabs the flat bar and can tuck under the side rail 16.

Tarpaulin 18 would be anchored to one side of the body 14 by being mounted to an elongated anchored support member 20 or permanent pipe which would be secured to one of the sides of body 14. The support member 20 could be attached to tarp 18 in any suitable manner. For example, support member 20 could be inserted in a pocket 22 at one side of tarp 18 and then is bolted through the tarp and fastened at spaced locations along the tarp through use of clips 24 or other suitable fasteners. Tarp 18 may include a second pocket 26 at its side remote from pocket 22. A movable support member or roller tube 28 would be inserted into pocket 26 and secured in any suitable manner such as by fasteners 30 at spaced locations along the length of the elongated movable support member. Movable support member 28 could be a two piece rod or tube, as illustrated, or could be of a one piece roller tube.

A pivot point assembly 32 is mounted to each of the front end and rear end of the body 14 laterally centrally between the sides of body 14. Pivot point assembly 32 includes a pivot pin 34 and a torsion spring 35. A pivot arm 36 is pivotally mounted to each pivot point assembly 32. Pivot arm 36 may take any suitable form. In a preferred practice of this invention pivot arm 36 is of straight arm design so that the tarp 18 will easily clear heaped loads in the body 14. Pivot arm 36 could be of multi-piece construction including a central member which would be telescoped over extensions 38, 40. Extension 38 is part of a pivot head assembly. One such assembly 42 is located at the front of body 14, while the other pivot head assembly 44 is at the rear of body 14. Extension 40 is part of pivot plate 46 which is pivotally mounted to pivot pin 34.

As later described, one of the pivot head assemblies, preferably the front pivot head assembly 42, is power driven while the other pivot head assembly 44 is an idler pivot head assembly. FIG. 1 illustrates the electrical cord 48 which would be used for powering the motor of pivot head assembly 42, as later described.

As previously indicated, the invention is not limited to side dump vehicles. Where the various components are referred to, for example, as “front” components, such components could actually be on the rear of the body with the opposite components on the front. Similarly, such “front” components could be on one of the sides of the body and the opposite components on the other side. Accordingly, when reference is made to various “front” components, such components in a broad sense might be considered as “first” components and the “rear” components might be considered as “second” components.

FIG. 1 also illustrates a traction roller 50, preferably made from rubber or other suitable traction material. Traction roller 50 is non-rotatably mounted on each end of movable support member or roller tube 28 outwardly of the front and rear ends of tarp 18. Each roller 50 is located between the end of tarp 18 and lip 15 spaced inwardly from lip 15. As later described traction roller 50 is one of the advantageous features of system 10.

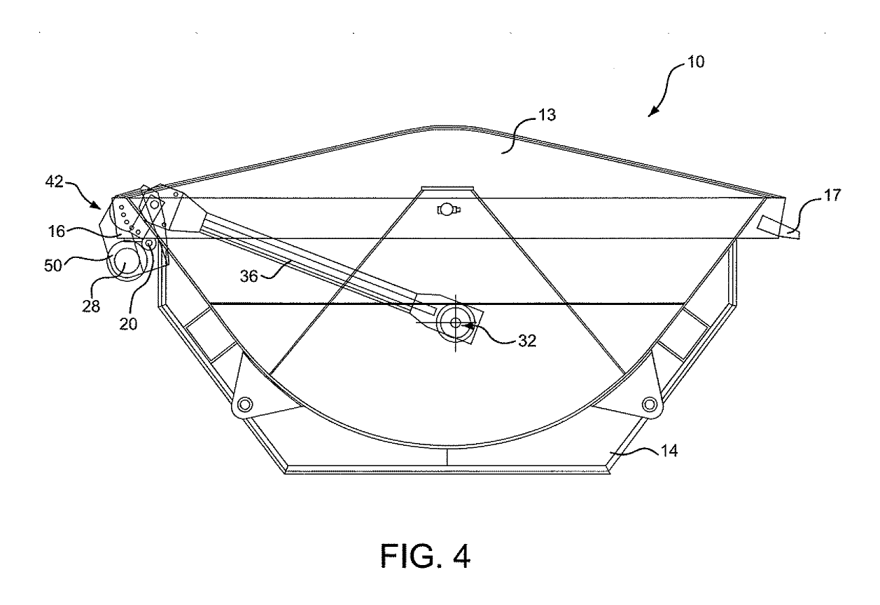

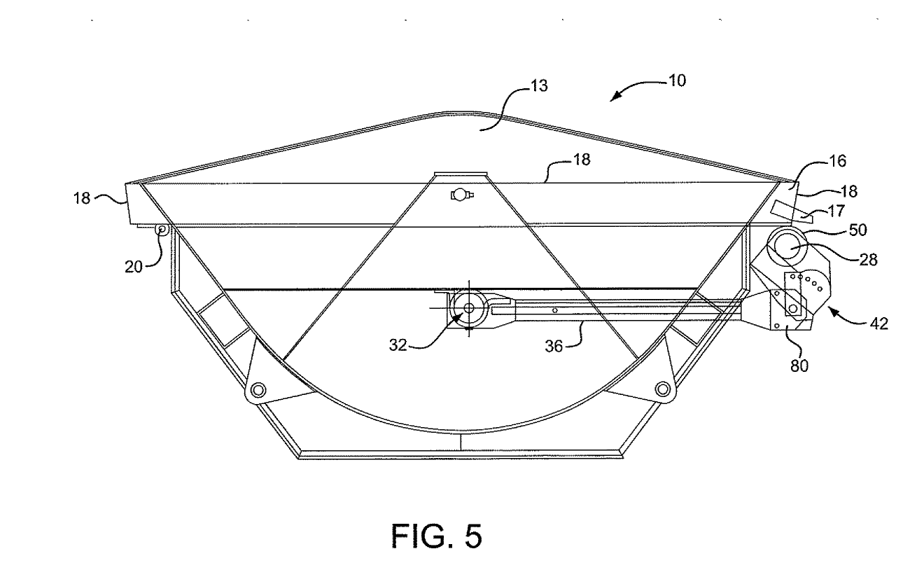

The system 10 would be essentially in one of three positions depending upon the load conditions and stage of operation of the vehicle 12. FIG. 2 illustrates system 10 in the relaxed position where the body 14 would be empty. FIG. 4 illustrates system 10 in its open position when the body 14 would be exposed for receiving the materials placed in the body or for dumping the materials or load from the body. FIG. 5 illustrates system 10 in its closed position when material in body 14 is covered.

As shown in FIG. 2 one end of tarp 18 is anchored to one side of body 14 at the location of anchored support member or pipe 20 with the aid of clips 24. Tarp 18 extends around and under the side rail 16. In this relaxed position there is no spring pressure from the springs 35 at the pivot assemblies 32 mounted to the front and rear of body 14. As shown in FIG. 2 the front pivot head assembly 42 is located generally below the side rail 16, and spaced from it. The rear pivot head assembly would have a similar location.

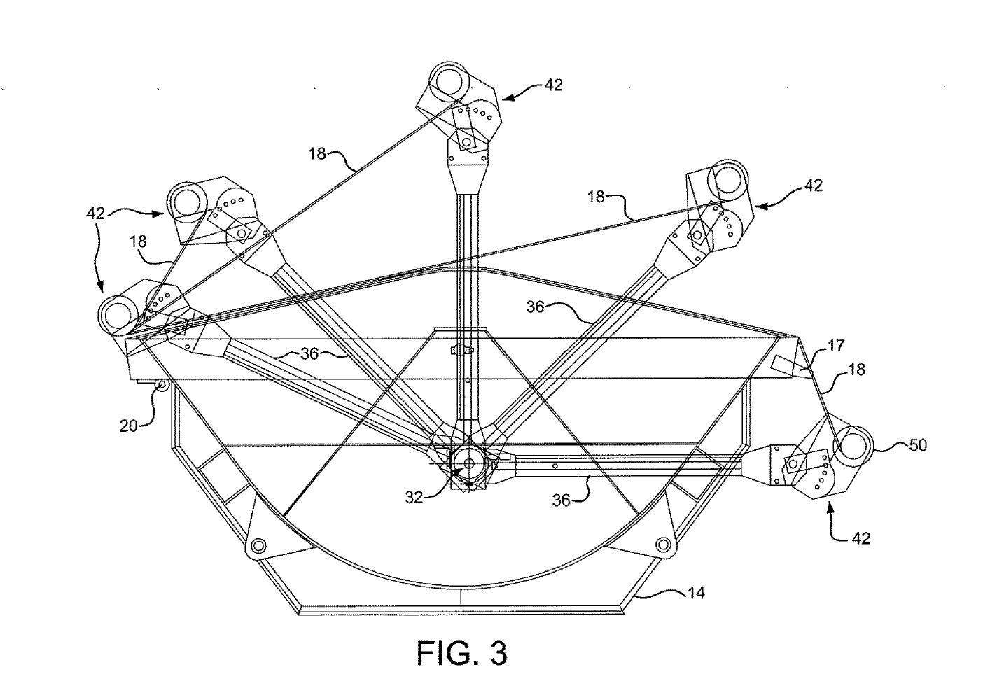

When it is desired to expose the top of body 14, the pivot arm 36 is rotated about pivot assembly 32 in a counterclockwise direction in response to tarp 18 being wound on support member 28 which thereby pulls the arm 36 in the counterclockwise direction. FIG. 3 illustrates the steps of rotation as the arm 36 swings from having its pivot head assembly 42 initially on one side of the body 14 and then moved toward the other side of body 14. During this pivotal movement tarp 18 winds around movable support member or roller tube 28.

FIG. 4 shows the system 10 in its fully open position where the top of body 14 between its front and rear walls 13 is completely exposed or open thereby permitting material to be placed into or dumped from body 14. As shown in FIG. 4 the tarp 18 and its movable support member or roller tube 28 are tucked under and disposed at the side rail 16.

When it is desired to cover the top of the vehicle body 14 so as to confine the contents of the body within the body, the arm 36 is moved in a clockwise direction from the position shown in FIG. 4 to the position shown in FIG. 5. As shown in FIG. 5 the system is in its tucked in condition disposed below side rail 16.

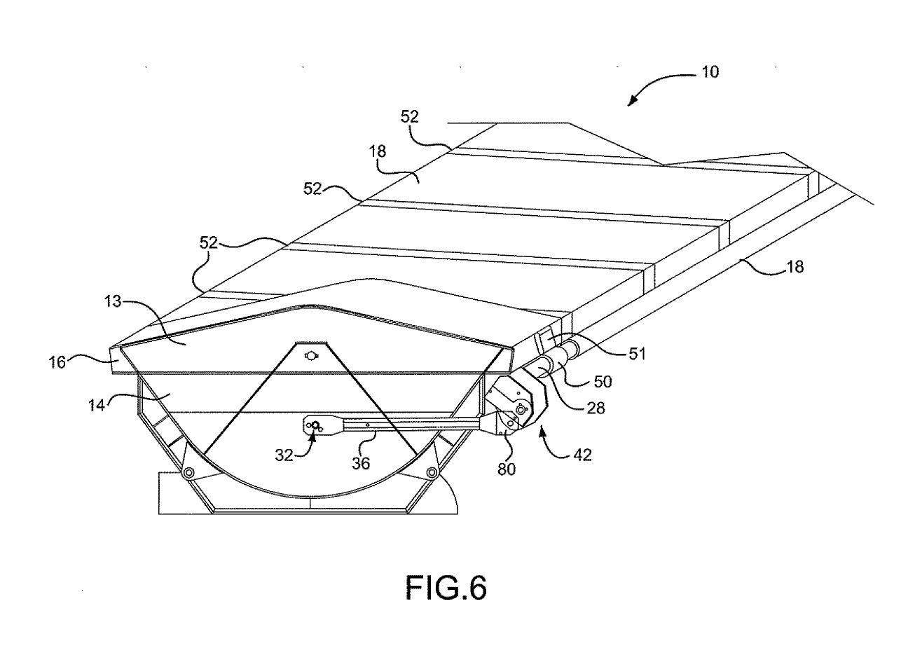

FIG. 6 illustrates the tarp 18 to include a plurality of stiffeners or seatbelts 52 which are sewn across the tarp in a lateral direction. Any suitable number and location of seatbelts 52 may be used. In a preferred practice of this invention the longitudinally spaced seatbelts 52 are located at the front, the rear and in line with caddies on the trailer or vehicle 12. These seatbelts 52 insure that the tarp 18 will roll up on the movable support member or pipe 28 throughout the tarp length to a consistent diameter. This is an improvement over conventional systems where the tarps roll up badly in the middle and allow the support pipe to droop.

FIG. 6 and other figures also illustrate the traction roller 50 which is preferably made of a suitable traction material such as rubber. Traction roller 50 is preferably dimensioned to have a diameter that would exceed the diameter of the tarp 18 in its fully rolled condition. Having the traction roller or roller grip 50 of a diameter greater than the diameter of the fully rolled tarp 18 is the preferred practice of this invention. The benefits of a traction roller, however, could still be achieved where the diameter of the traction roller is the same as the diameter of the rolled up tarp and could even be achieved where the diameter of the traction roller is slightly less than that of the rolled up tarp. In that sense this aspect of the invention could be broadly practiced where the diameter of the traction roller is “slightly less” by being at least 60% of the diameter of the rolled up tarp 18, or more preferably at least 80% or 90% or 95%. The use of a large diameter traction roller differs from known practices where a protective coating or layer may be on the roller tube. In such prior practices, a thin protective coating or layer would be located to be centered at the lip 15 for contacting the flat bar 17. A lip can wear a groove into the roller tube if it makes contact with the roller tube. In a preferred practice of this invention the diameter of the roller grip or traction roller 50 would be also larger than the protruding lip 15. A further preferred feature of traction roller 50 is that it is located between the end of tarp 18 and the lip 15 and is spaced inwardly from the lip 15 in contrast to the known thin protective layer which would be aligned with the lip 15.

Where the diameter of the traction roller 50 is slightly less than the diameter of the rolled up tarp 18, then from the open position the tarp would unwind a couple of times staying in the same position until the traction roller 50 is able to engage the body surface and then the system would snap over to the amount it unrolled. While this is not the most preferred manner of practicing the invention, it is one broad practice, as long as the tarp has not unrolled too large a distance before snap back. In the most preferred practice, however, where the diameter of the traction roller is greater than the diameter of the rolled up tarp there is assurance that the traction roller 50 makes contact with the trailer body before there is any contact by the tarp. As a result, the system effectively climbs out and into the open and closed positions.

In the preferred practice of this invention traction is achieved with respect to the support member or roller tube 28 and the vehicle body 14 through use of the traction rollers 50 which are located on the support member or roller tube 28 longitudinally outwardly of the tarp 18. In a variation of the invention traction between the support member or roller tube 28 and the vehicle body 14 could also be achieved by providing traction structure, such as a traction pad 51 as shown in FIG. 6, or any other suitable material, but on the body 14 itself at a location longitudinally outwardly of the tarp 18, where the support member or roller tube 28 would be disposed for contacting the vehicle body. The thickness of such traction pad or other traction structure would be similar to the relational thickness of the traction roller 50 and the rolled up tarp 18. Thus, in the broad practice of the invention the traction pad, which could be made of rubber or any other suitable traction material, would have a thickness at least no less than slightly smaller than the diameter of the fully rolled up tarp diameter such as at least 60% of the diameter. Preferably the thickness should be at least as large as the fully rolled up tarp diameter and most preferably larger than the fully rolled up tarp diameter. The outer surface of the traction structure could be of any suitable shape, such as flat, curved, pointed or irregular. Such traction structure can be located in the form of strips or pads on the outside surface of the body 14 down the side of the body at any location where the movable support member 28 would be in a position to contact the body and thereby be located between the movable support member 28 and the body for providing the desired traction.

If desired, the invention could be practiced by providing such traction structure on the vehicle body in addition to providing a traction roller on the movable support member. In that sense the traction structure would comprise both the pad 51 and the roller 50. In such practice of the invention the combined thickness of the traction pad on the vehicle body and the diameter of the traction roller would be the thickness of the traction structure which would preferably be at least 60% of the diameter of the rolled up tarp and more preferably at least as large as the diameter of the rolled up tarp and most preferably larger than the diameter of the rolled up tarp.

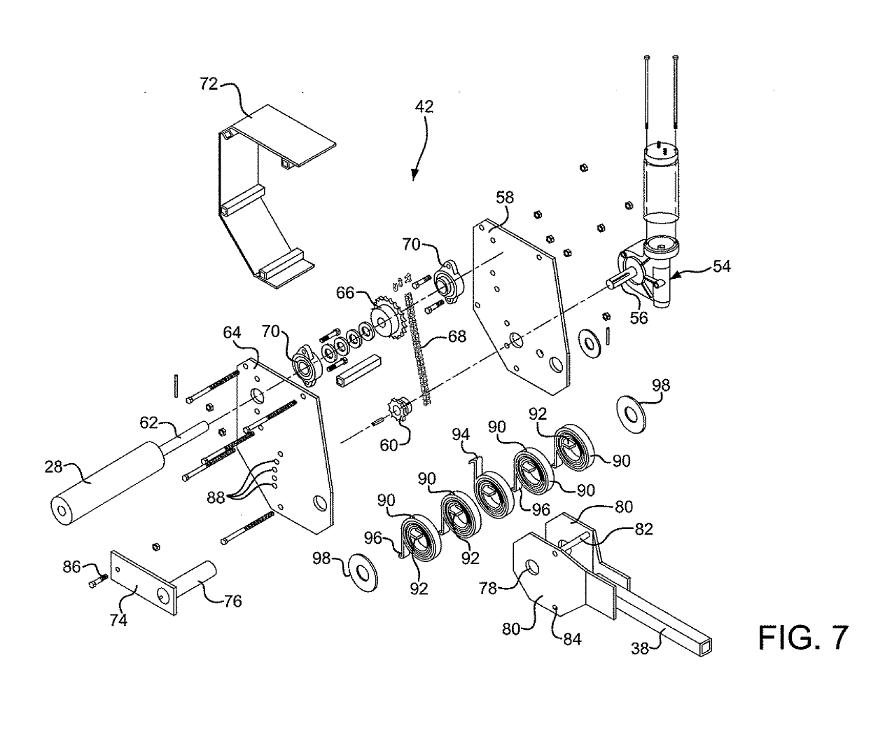

FIG. 7 is an exploded view of the front pivot head assembly 42. Much of the structure of front pivot head assembly 42 would be duplicated in rear idler pivot head assembly 44 except that rear pivot head assembly 44 does not require the components associated with front pivot head assembly 42 being powered or motor driven.

As shown in FIG. 7 front pivot head assembly 42 is provided with a motor 54 having a motor shaft 56. Motor shaft 56 extends through housing plate 58 and engages drive motor sprocket 60. Movable support member or roller tube 28 has an extension 62 which is inserted through housing plate 64 and engages roller sprocket 66. A drive chain 68 connects drive motor sprocket 60 with movable member or roller sprocket 66. The result of the structure connecting the motor 54 with roller tube 28 is such that the roller tube 28 is not directly mounted to the motor output shaft 56. The natural position of such a roller tube would be to follow an elliptical pattern, particularly when it could be 30 to 40 feet long and only supported on each end. Because of the displaced connection, the motor 54 is not mounted directly to roller tube 28. As a result, the internal gears and seals are not affected by any such elliptical rotation. As a result, the roller end is the part that takes the load of the roller tube 28 along with bearings 70. Preferably, roller sprocket 66 has substantially more teeth than motor sprocket 60. For example, in one practice of this invention driven roller sprocket 66 has eighteen teeth, while drive motor sprocket 60 has nine teeth, thus providing a 2:1 ratio. Although FIG. 7 illustrates a practice of the invention where the driven roller sprocket 66 has more teeth than the drive motor sprocket 60 and specifically at a 2:1 ratio, other ratios could be used. For example, the invention could be broadly practiced where the ratio is between 10:1 and 1:10 and preferably between 5:1 and 1:5.

The various components located from motor shaft 56 to tube extension 62 would be housed between housing plates 58 and 64 and housing cover 72.

FIG. 7 illustrates a further aspect of this invention. As shown therein pivot head assembly 42 includes an indicator plate 74. A shaft 76 extends from indicator plate 74 and would be inserted through aligned holes 78 in the walls 80 of the extension 38 which telescopes into arm 36. Shaft 76 thereby functions as a pivot shaft around which pivot head assembly 42 may rotate at its pivot connection to arm 36. Walls 80 are held in the spaced apart position by welded pin 82. Walls 80 also have aligned holes 84 which would receive a through bolt (not shown).

Indicator plate 74 includes a pin 86 which would be selectively inserted into one of the set of holes 88 in housing plate 64 to control the orientation of the indicator plate with respect to the pivot arm 36 for purposes later described.

As also shown in FIG. 7 a plurality of torsion springs 90 is provided which would fit over shaft 76. The inner leg 92 of each torsion spring would be inserted into or engaged with a slot in the shaft 76. The invention could be practiced with only 2 oppositely directed torsion springs or with any suitable number of torsion springs having a mixture of oppositely directed springs. In a preferred practice of this invention there are at least 3 and preferably 5 torsion springs. As shown in FIG. 7 the central torsion spring 90 has its outer leg 94 facing up while the outer legs 96 of the remaining torsion springs 90 face down. Leg 94 engages the pin 82. The legs 96 would engage the through bolt extending through holes 84. The torsion springs would be mounted on shaft 76 between walls 80, 80 with a washer 98 outwardly of the set of torsion springs.

Although FIG. 7 illustrates the use of torsion springs, the invention could be practiced by using other techniques. One alternative is a strut method using an adjustable gas spring with a neutral position or a strut with two different sized compression springs with neutral position. The two different sized compression springs would give more power in one direction than the other. And the adjustable gas spring would provide more pressure or Newtons in one direction than in the other direction.

Idler pivot head assembly 44 would also include an indicator plate and its associated structure.

As shown in FIG. 7 indicator plate 74 can be adjusted in its selected orientation in accordance with the placement of pin 86 in a selected one of the holes 88 which give more or less spring pressure in the tucked and untucked positions. The indicator plate 74 can be independently adjusted to different positions on both front pivot head assembly 42 and rear pivot head assembly 44. By doing this the system can be fine tuned when tucking and untucking in the front and rear of the systems to provide balance. This also allows system 10 to adapt to different body sizes.

FIG. 7 shows the springs 90 which give the tuck and untuck pressure. By rotating indicator plate 74 when selecting a hole 88 for pin 86, the spring pressure will increase or decrease. It is to be understood that system 10 thereby permits the spring pressure of one pivot head assembly to differ from the spring pressure of the other pivot head assembly.

By having the outer leg of one of the torsion springs 90 face in the opposite direction than the other torsion springs, the torsion springs can be turned to give more or less pressure in the clockwise or counter-clockwise direction. Having one of the springs of a different orientation permits fine adjustment of the spring force or pressure. The torsion spring pressure in different directions allows for more flexibility for different weight tarps and body configurations.

In operation when it is desired to activate the system 10, the reversible motor 54 would be turned on. This could be done from any suitable location including from the cab of the vehicle by the user simply pushing a button. Motor shaft 56 through its transmission structure of the sprockets 60 and 66 and the chain 68, then causes roller tube or movable support member 28 to spin in either a clockwise or counter-clockwise direction depending on the direction of rotation of shaft 56. The spinning of the movable support member 28 causes the tarp 18 to roll onto or from movable support member 28 and thereby forces the system to open over the body 14 by causing the pivot arms 36 (which are connected to the movable support member 28 through their respective pivot head assemblies) to rotate about the pivot pin 34 from each pivot point assembly 32. When the movable support member 28 reaches the side of the vehicle body 14, the traction roller 50 at each end of the movable support member or roller tube 28 will start to engage the elongated side rail 16 on the respective side of the body 14. When the system 10 has reached the completely open position shown in FIG. 4, the pivot head assemblies 42,44 are in a tucked position. The pivot head assemblies are partially below and located at side rail 16. Rollers 50 are below and in contact with side rail 16. Roller tube 28 is below side rail 16. FIG. 4 shows how the pivot head assembly 42 conforms to the shape of the body 14.

When the system 10 rolls into this open position of FIG. 4, tarp 18 forces the pivot head assemblies 42, 44 to pivot and tuck into the proper position. At this time, the pivot arms 36 will have spring pressure from the springs 35 at each pivot point assembly. This allows the system 10 to return to the closed position of FIG. 5 when the motor 54 drives its shaft 56 in a clockwise direction. When the system 10 begins to reach the closed position the support member 28 momentarily engages the flat bar 17 and the traction rollers 50 grip the body 14. The pivot head assemblies 42, 44 are untucked when moving from the open to the closed position. Spring pressure from springs 35 push the system to the closed position of FIG. 5. The traction rollers 50 are the only members of system 10 which touch the side of the body thereby allowing the system 10 to have traction to climb in and out of its closed position.

The invention can be practiced with the system 10 being mounted on either side of the body 14. System 10 can be easily installed and electrically operated from inside the cab providing the ability to cover loads that extend above the sides of the body 14. System 10 is particularly adapted for side dump trailers or other side dump vehicles and can be an all aluminum electric system which is able to utilize many of the same components from the known Flip N'Go System of Cramaro Tarpaulin Systems, Inc. The springs, aluminum arm extrusions and the motor can all be interchangeable. With the push of a button the system 10 easily clears loads because of the straight arm design. The roller tube 28 tucks under the side rail 16 of the trailer body 14 in both the open and closed positions of the system.

What is claimed is:

1. A tarpaulin cover system for selectively covering and uncovering the body of a vehicle having a front side and an opposite rear side and having opposite lateral sides, comprising an elongated anchored support member for being mounted to one of the opposite sides of the vehicle body and to extend generally the length of that side of the vehicle body, a tarpaulin having two spaced opposite sides, one of said tarpaulin sides being secured to said anchored support member for being fixedly mounted at the one side of the vehicle body, an elongated movable support member, the other of said tarpaulin sides being secured to said movable support member, a first pivot point assembly for being mounted at one side of the vehicle body, a second pivot point assembly for being mounted at the opposite side of the vehicle body, a first pivot arm pivotally mounted to said first pivot point assembly, a second pivot arm pivotally mounted to said second pivot point assembly, a first pivot head assembly mounted to said first pivot arm remote from said first pivot point assembly, a second pivot head assembly mounted to said second pivot arm remote from said second pivot point assembly, said movable support member being mounted to and located between said first pivot head assembly and said second pivot head assembly, one of said first pivot head assembly and said second pivot head assembly being power operated to pivot its pivot arm about its pivot point assembly and to thereby pivot the other pivot arm and said tarpaulin whereby said tarpaulin is selectively moved back and forth over the vehicle body from one of the opposite sides of the body to the other of the opposite sides of the body, a traction roller on said movable support member outwardly of said tarpaulin for creating traction between said movable support member and the vehicle body when said movable support member is disposed at the vehicle body, and said traction roller having a diameter no less than slightly smaller than the diameter of said tarpaulin when said tarpaulin is fully rolled on said movable support member in an open position of said system.

2. The system of claim 1 wherein said traction roller is mounted to said movable support member outwardly of each end of said tarpaulin.

3. The system of claim 2 wherein each of said traction rollers has a diameter at least no less than 60% of the diameter of said tarpaulin when said tarpaulin is fully rolled on said movable support member in the open position of said system.

4. The system of claim 3 wherein said diameter of each of said traction rollers is at least as great as the diameter of said rolled up tarpaulin.

5. The system of claim 4 wherein said diameter of each of said traction rollers is greater than the diameter of said rolled up tarpaulin.

6. The system of claim 1 wherein said first pivot head assembly is pivotally mounted at a pivot connection to said first pivot arm, and said second pivot head assembly being pivotally mounted at a pivot connection to said second pivot arm, each of said pivot connections including a shaft connecting said respective pivot head assembly to its respective pivot arm, and spring structure for applying spring pressure at said pivot connection.

7. The system of claim 6 wherein the spring structure of each of said pivot connections is separately adjustable in spring pressure whereby the spring pressure at said first pivot head assembly is capable of differing from the spring pressure at said second pivot head assembly.

8. The system of claim 7 wherein said pivot connection includes a plurality of torsion springs forming a set of springs with a central spring and with outer springs, each of said springs having an inner leg mounted to a shaft in said respective pivot head assembly, said central spring having an outer leg facing upwardly and mounted at said pivot connection, and each of said outer springs having a lower leg facing downwardly and mounted at said pivot connection.

9. The system of claim 8 including an indicator plate in each of said pivot head assemblies, said shaft being mounted to said indicator plate, a pin on said indicator plate, a housing wall in said pivot head assembly, a set of holes in said housing wall, and said pin being selectively inserted into one of said set of holes to control the orientation of said indicator plate.

10. The system of claim 1, in combination with a side dumping vehicle body having an open top, said first pivot point assembly being a front pivot point assembly mounted to the front side of said body laterally centrally between the lateral sides of said body, said second pivot point assembly being a rear pivot point assembly mounted to the rear of said body laterally centrally between the lateral sides of said body, and each of said pivot arms being of straight shape.

11. The system of claim 10 wherein said body has a side rail extending along each lateral side thereof, said system being movable to and from three separate positions, one of said positions being a relaxed position wherein said tarpaulin covers said top of said body and wherein said movable support member is located below and spaced from said side rail on a side of said body remote from said anchored support member, a second position being an open position wherein said top of said body is uncovered and wherein said tarpaulin is rolled around said movable support member with said movable support member being on the same side of said body as said anchored support member and wherein said movable support member is tucked under and located at said side rail, and the third position being a closed position wherein said tarpaulin covers said top of said body and said movable support member is disposed on the side of said body opposite the side where said anchored support member is mounted and wherein said movable support member is tucked under and located at said side rail.

12. The system of claim 10 wherein said front pivot head assembly is motorized and said rear pivot head assembly is an idler assembly.

13. The system of claim 12 wherein said front pivot head assembly includes a motor having a motor shaft, a transmission assembly between said motor shaft and said movable support arm, said transmission assembly comprising a drive motor sprocket mounted at said motor shaft, a driven sprocket mounted at said movable support member to drive said movable support member, and a drive chain between said sprockets.

14. The system of claim 1 wherein said tarpaulin includes a plurality of longitudinally spaced seatbelts extending transversely across said tarpaulin, one of said seatbelts being located at one end of said tarpaulin, another of said seatbelts being located at another end of said tarpaulin, at least one intermediate seatbelt, and said seatbelts providing stiffness to said tarpaulin to facilitate said tarpaulin rolling up on said movable support member.

15. The system of claim 1 wherein said first pivot head assembly includes a motor having a motor shaft, a transmission assembly between said motor shaft and said movable support arm, said transmission assembly comprising a drive motor sprocket mounted at said motor shaft, a driven sprocket mounted at said movable support member to drive said movable support member, and a drive chain between said sprockets.

16. A tarpaulin cover system, in combination therewith, a vehicle having a body with a front side and an opposite rear side and having opposite lateral sides, said cover system comprising an elongated anchored support member mounted to one side of said vehicle body and extending generally the length of that side of said vehicle body, a tarpaulin having two spaced opposite sides, one of said tarpaulin sides being secured to said anchored support member for being fixedly mounted at the one side of said vehicle body, an elongated movable support member, the other of said tarpaulin sides being secured to said movable support member, a first pivot point assembly mounted at one side of said vehicle body, a second pivot point assembly mounted at the opposite side of said vehicle body, a first pivot arm pivotally mounted to said first pivot point assembly, a second pivot arm pivotally mounted to said second pivot point assembly, a first pivot head assembly mounted to said first pivot arm remote from said first pivot point assembly, a second pivot head assembly mounted to said second pivot arm remote from said second pivot point assembly, said movable support member being mounted to and located between said first pivot head assembly and said second pivot head assembly, one of said first pivot head assembly and said second pivot head assembly being power operated to pivot its pivot arm about its pivot point assembly and to thereby pivot the other pivot arm and said tarpaulin whereby said tarpaulin is selectively moved back and forth over said vehicle body from one of the sides of said body to the other of the opposite sides of said body, traction structure longitudinally outwardly of said tarpaulin located between said movable support member and said vehicle body to provide traction between said movable support member and said vehicle body, and said traction structure having a thickness no less than slightly smaller than the diameter of said tarpaulin when said tarpaulin is fully rolled on said movable support member in an open position of said system.

17. The system of claim 18 wherein said traction structure has a thickness at least no less than 60% smaller than the diameter of said tarpaulin when said tarpaulin is rolled on said movable support member in the open position of said system.

18. The system of claim 17 wherein said traction structure thickness is at least as great as the diameter of said rolled up tarpaulin.

19. The system of claim 18 wherein said traction structure thickness is greater than the diameter of said rolled up tarpaulin.

20. The system of claim 16 wherein said traction structure is mounted to said vehicle body, and said traction structure being located to contact said movable support member at each end of said movable support member outwardly of said tarpaulin.

21. The system of claim 20 wherein said traction structure mounted to said body includes a pad/strip fixedly secured to said body, said traction structure further including a traction roller mounted at each end of said movable support member outwardly of said tarpaulin, and said thickness of said traction structure comprising the combined thickness of said pad/strip and of the diameter of said traction roller.

22. The system of claim 16 wherein said traction structure comprises a traction roller mounted to each end of said movable support member outwardly of said tarpaulin.

23. The system of claim 16, wherein said vehicle is a side dumping vehicle body having an open top, said first pivot point assembly being a front pivot point assembly mounted to the front of said body laterally centrally between the lateral sides of said body, said second pivot point assembly being a rear pivot point assembly mounted to the rear of said body laterally centrally between the lateral sides of said body, each of said pivot arms being of straight shape, said body having a side extending along each side thereof, said system being movable to and from three separate positions, one of said positions being a relaxed position wherein said tarpaulin covers said top of said body and wherein said movable support member is located below and spaced from said side rail on a side of said body remote from said anchored support member, a second position being an open position wherein said top of said body is uncovered and wherein said tarpaulin is rolled around said movable support member with said movable support member being on the same side of said body as said anchored support member and wherein said movable support member is tucked under and located at said side rail, and the third position being a closed position wherein said tarpaulin covers said top of said body and said movable support member is disposed on the side of said body opposite the side where said anchored support member is mounted and wherein said movable support member is tucked under and located at said side rail, and each of said traction structure being in contact with said movable support member and with said side rail in said open and said closed positions.
